(19) United States
(12) Patent Application Publication
(10) Pub. No.: US 2008/0004763 A1
(43) Pub. Date: Jan. 3, 2008

(54) Method and system for preventing excessive tire wear on machines

(75) Inventors: Stuart Clayton Johnson, Peorla, IL (US); Julie Ann Gannon, Washington, IL (US); Christopher Kent Hoadley, Kewanee, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/477,870

(22) Filed: Jun. 30, 2006

(51) Int. Cl. G06F 19/00

(52) U.S. Cl. 701/29; 340/442

(57) ABSTRACT

A method for automatically controlling the ton-miles-per-hour of a plurality of tires on a machine includes determining the weight of a load supported by the tires, determining the ground speed of the machine, and compensating for uneven distribution of the load on the tires. The ton-miles-per-hour for each tire is determined based on the compensated load distribution and the ground speed. An operator of the machine is notified if the calculated ton-miles-per-hour exceeds a predetermined threshold. The method also includes adjusting at least one operational aspect associated with the machine if the calculated ton-miles per hour exceeds the predetermined threshold.

### TECHNICAL FIELD

The present disclosure relates generally to monitoring tire wear for machines and, more particularly, to methods and systems for preventing excessive tire wear on machines.

### BACKGROUND

As a machine, e.g., truck, travels, the tires on the machine generate heat due to the friction of the tires on the surface that the machine is traveling on. The heat generated is a function of the load being carried by the machine and the speed that the machine travels. Tire wear can be attributed to the generation of heat for long periods of time. In addition, excessive amounts of heat generation can lead to early tire failure.

The conventionally accepted industry standard for measuring heat generation and tire wear is to determine a ton-miles-per-hour value for each of the tires of a machine during operation of the machine. One such method is described in U.S. Pat. No. 6,044,313 (“the '313 patent”) to Gannon. The method of the '313 patent calculates the ton-miles-per-hour for each tire of a machine, based on the respective load of each tire. If the ton-miles-per-hour associated with one or more tires exceeds a predetermined threshold, a notification may be provided to an operator of the vehicle, so that measures can be taken to prevent excessive tire wear.

In certain situations, however, simply notifying an operator of an increased ton-miles-per-hour condition may not be adequate in preventing machine damage. For example, if an operator of the work machine ignores the notification or otherwise fails to take the necessary preventative measures to reduce the ton-miles-per-hour, damage may still occur.

The presently disclosed method and system for preventing excessive tire wear on machines are directed to overcoming one or more of the problems as set forth above.

### SUMMARY OF THE INVENTION

In accordance with one aspect, the present disclosure is directed toward a method for automatically controlling the ton-miles-per-hour of a plurality of tires on a machine. The method may include determining the weight of a load supported by the tires, determining the ground speed of the machine, and compensating for uneven distribution of the load on the tires. The ton-miles-per-hour for each tire may be determined based on the compensated load distribution and the ground speed. An operator of the machine may be notified if the calculated ton-miles-per-hour exceeds a predetermined threshold. The method may also include adjusting at least one operational aspect associated with the machine if the calculated ton-miles per hour exceeds the predetermined threshold.

According to another aspect, the present disclosure is directed toward a method for controlling ton-miles-per-hour of a plurality of tires on a machine. The method may include determining the weight of a load supported by the tires, determining the ground speed of the machine, and compensating the determined weight for uneven distribution of the load on the tires. The ton-miles-per-hour for each tire may be determined based on the compensated load distribution and the ground speed. The method may also include providing a speed control signal to one of a transmission controller or an engine controller associated with the machine if the ton-miles-per-hour exceeds a predetermined threshold, wherein the speed control signal is adapted to limit the ground speed of the machine.

In accordance with yet another aspect, the present disclosure is directed toward a system for controlling the ton-miles-per-hour of a plurality of tires on a machine. The system may include a payload monitor located on the machine that generates a payload signal, a ground speed monitor located on the machine that generates a ground speed signal, and a control system located on the machine. The control system may be configured to receive the payload signal and the ground speed signal, compensate for uneven distribution of the load on the tires, and responsively determine the ton-miles-per-hour for each tire. The control system may also be configured to notify an operator if the calculated ton-miles-per-hour exceeds a predetermined threshold, and adjust at least one operational aspect associated with the machine if the calculated ton-miles per hour exceeds the predetermined threshold.

### BRIEF DESCRIPTION OF THE DRAWINGS

FIG. 1 is a diagrammatic illustration of a machine used to haul a load;

FIG. 2 is a diagrammatic illustration of a top view of a portion of a machine;

FIG. 3 is a block diagram illustrating an exemplary apparatus, consistent with certain disclosed embodiments;

FIG. 4 is a flow diagram illustrating an exemplary method for controlling the ton-miles-per-hour of a plurality of tires on a machine;

FIG. 5 is a flow diagram illustrating an exemplary method of determining the weight of a load; and

FIG. 6 is a scatter plot illustrating an exemplary application, consistent with the disclosed embodiments.

### DETAILED DESCRIPTION

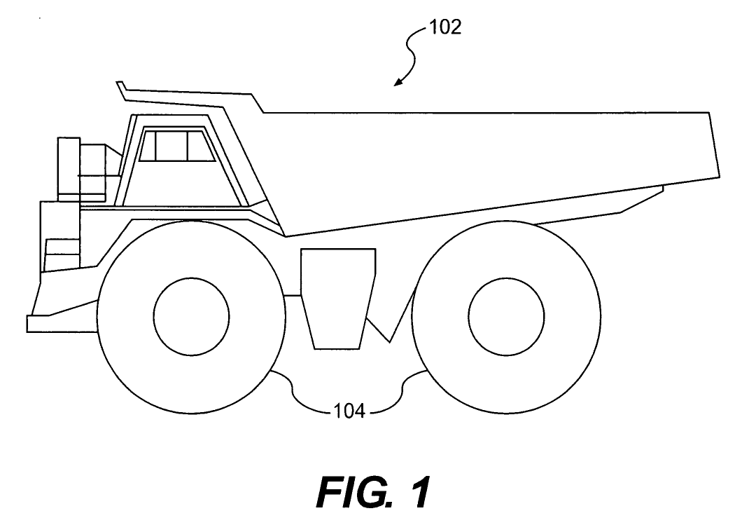

FIG. 1 provides a diagrammatic illustration of an exemplary machine 102 according to certain disclosed embodiments. Machine 102 may include any machine for performing a task associated with an industry such as mining, construction, farming, transportation, power generation, manufacturing, and any other type of industry. Non-limiting examples of machines include cranes, haulers, front end loaders, tractors, on and off-highway vehicles, automobiles, excavators, dump trucks, or any other suitable machine. Machine 102 may include, among other things, a power source for producing a power output, an electronic control unit (ECU), and one or more traction devices, such as tires 104. Although machine 102 is illustrated as an off-road mining truck, it is contemplated that machine 102 may include any suitable type of mobile or stationary machine, such as those described above.

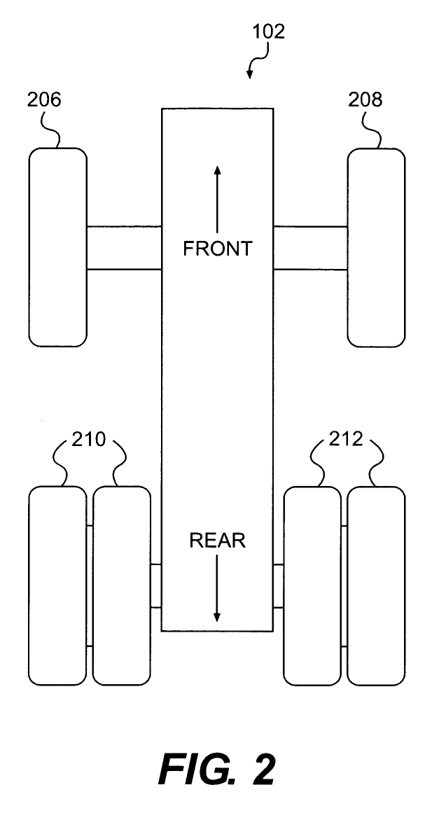

Machine 102 may include a plurality of tires 104 to enable machine 102 to move about. As shown in FIG. 2, machine 102 may have at least one left front tire 206, at least one front right tire 208, at least one left rear tire 210, and at least one right rear tire 212. In particular, the embodiment of FIG. 2 may include one left front tire 206 and one right front tire 208, and two left rear tires 210 and two right rear tires 212. However, other combinations of tire arrangements may also apply. For example, machine 102 may have more than one set of tires at either the front or the rear. As an example, machine 102 may have two sets of tires, e.g., dual axles, at the rear of machine 102.

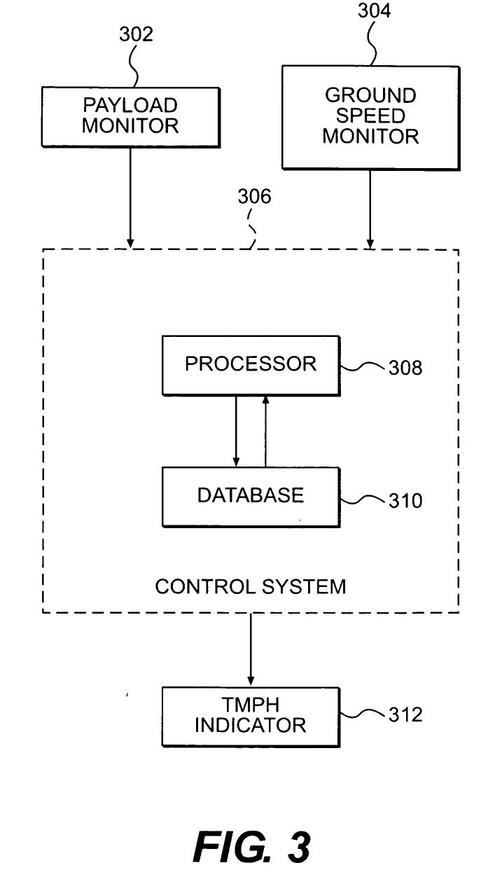

Referring now to FIG. 3, a block diagram of an exemplary system for determining ton-miles-per-hour is shown. A payload monitor 302 may be configured to detect the weight of a load on machine 102. Examples of payload monitors include strut pressure monitors, truck bed pressure monitors, hydraulic cylinder and linkage pressure monitors, and any other type of sensor.

A ground speed monitor 304 may be used to determine the speed of machine 102 as the machine travels. In one embodiment, ground speed monitor 304 may detect the output speed of a transmission on machine 102. However, the ground speed can be measured at other locations on machine 102, e.g., wheels, driveshaft, etc.

Payload monitor 302 and ground speed monitor 304 may each generate respective payload and ground speed signals, which may be provided to a control system 306. The control system 306 may include a processor 308, such as a microprocessor, and a database 310. The database 310 may be configured to store and retrieve data by the processor 308.

The control system 306 may be configured to deliver ton-miles-per-hour values to a tons-miles-per-hour (TMPH) indicator 312 located on machine 102. The TMPH indicator 312 may display a value of tons-miles-per-hour to an operator. Alternatively, the TMPH indicator 312 may be located at a remote site. Values of tons-miles-per-hour may be transmitted through a medium such as, for example, an RF link (not shown). The TMPH indicator 312 may include any of a type of suitable display means, including graphic, numeric, warning light, etc.

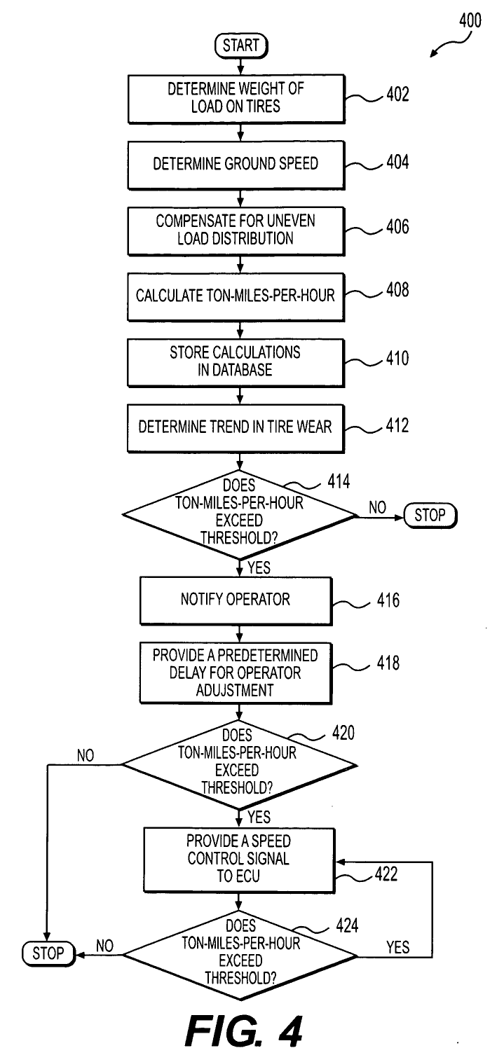

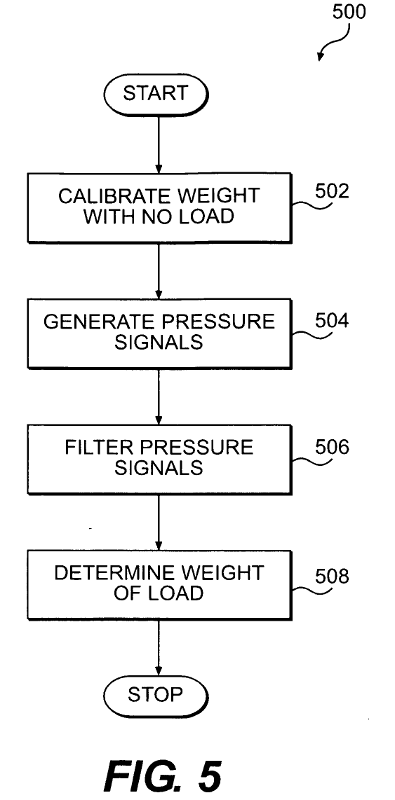

Referring to FIGS. 4 and 5, flow diagrams illustrating a method for monitoring tons-miles-per-hour are shown. FIG. 4 provides a flowchart 400 depicting an exemplary method for controlling the ton-miles-per-hour associated with machine 102. In a first control block 402, the weight of a load on the tires 104 is determined. In one embodiment, the weight of the load may be measured by a payload monitor 302 directly. An alternate embodiment is described below with reference to FIG. 5.

In a second control block 404, the ground speed of machine 102 may be determined. Control then proceeds to a third control block 406, where compensation is performed for uneven load distributions on the tires 104. For example, in certain machine environments and/or applications load hauling machines may not necessarily be configured to uniformly distribute loads during machine operation. For example, an off road mining truck may be designed to carry 60% of a load over the rear tires and the remaining 40% of the load over the front tires to achieve stability during transport.

In a fourth control block 408, the processor 308 in the control system 306 may determine the ton-miles-per-hour for each tire 104 as a function of the load distribution and the ground speed. The ton-miles-per-hour may be determined using a variety of methods, which are described in detail below.

In one embodiment, the ton-miles-per-hour for the front tires of 206, 208 and the ton-miles-per-hour for the rear tires 210, 212 may be calculated by multiplying the load by the ground speed by respective front and rear load distribution ratios. For the 60%/40% ratios described above, the following equations may be used:

TMPH_{REAR}=(EVW+PAYLOAD)·GROUND SPEED·0.6 (Eq. 1)

TMPH_{FRONT}=(EVW+PAYLOAD)·GROUND SPEED·0.4 (Eq. 2)

where EVW is the empty vehicle weight of machine 102.

In another embodiment, the front and rear weight distribution ratios may be different for no load conditions than for full load conditions. The difference compensates for conditions where adding a load causes the distribution of the weight on the tires 104 to change. For example, the load distribution for an empty off road mining truck may be 50% over the rear tires and 50% over the front tires. However, when a load is added, the load distribution may change to 67% over the rear tires and 33% over the front tires. Since an off road mining truck will travel as much empty as loaded, the change in load distribution will have a substantial effect on ton-miles-per-hour calculations.

The equations for the second embodiment are:

TMPH_{REAR}=(EVW+PAYLOAD)·GROUND SPEED·K_{REAR} (Eq. 3)

TMPH_{FRONT}=(EVW+PAYLOAD)·GROUND SPEED·K_{FRONT} (Eq. 4)

where, using the above example, K_{REAR} is 0.5 empty and 0.67 loaded, and K_{FRONT} is 0.5 empty and 0.33 loaded.

Another exemplary embodiment of the present disclosure is illustrated in flowchart 500 of FIG. 5. In a first control block 502, the weight of machine 102 may be determined by payload monitor 302 with no load. The weight may subsequently be calibrated to produce a calibration constant K to set the payload at no load to zero as shown by the following equation:

PAYLOAD=0=k_{f}(LF_{EMPTY}+RF_{EMPTY})+kᵣ(LR_{EMPTY}+RR_{EMPTY}) (Eq. 5)

where k_{f} and kᵣ are front and rear strut pressure to payload conversion constants, respectively.

The payload when a load is added may then be determined using the following equation:

PAYLOAD=0=k_{f}(ΔLF+ΔRF)+kᵣ(ΔLR+ΔRR)+K (Eq. 6)

where the symbol Δ indicates that the strut pressures LF, RF, LR, and RR are the changes in strut pressures from no load.

In a second control block 504, a set of pressure signals may be generated by payload monitor 302 in response to the pressure created by a load added to machine 102. The pressure signals may be delivered to the control system 306 where, in a third control block 506, the pressure signals may be filtered using standard signal filtering techniques to remove noise, spikes, and the like. The signal components that are filtered may be caused by noise common to electronic signal generators, and may also be the result of pressure fluctuations in payload monitor 302 caused by bumps and holes on a road surface as machine 102 travels over the road.

The filtered pressure signals may then used to determine the distribution of the payload on machine 102, using any suitable distribution formula, such as one of the distribution embodiments described above. For example, the payload at each of the tires 104 for the front and rear tires on machine 102 may be determined by:

$$\begin{matrix}{PAYLOAD}_{FRONT} = [ \frac{( 0.33 \cdot PAYLOAD ) + {k}_{f} ( Δ {LF}_{FILTERED} + Δ {RF}_{FILTERED}}{NUMBER OF FRONT TIRES} ] \\ and & ( Eq . 7 ) \\ {PAYLOAD}_{REAR} = [ \frac{( 0.67 \cdot PAYLOAD ) + {k}_{r} ( Δ {LR}_{FILTERED} + Δ {RR}_{FILTERED}}{NUMBER OF REAR TIRES} ] & ( Eq . 8 )\end{matrix}$$

where 0.33 and 0.67 are exemplary ratios of load distribution from front to rear of the machine. The terms ΔXX_{FILTERED} may account for changes in load distribution as machine 102 travels due to bumps, potholes, and the slopes of grades.

The ton-miles-per-hour for the front and rear tires can then be determined by:

TMPH_{FRONT}=(EVW+PAYLOAD_{FRONT})·GROUND SPEED (Eq. 9)

and

TMPH_{REAR}=(EVW+PAYLOAD_{REAR})·GROUND SPEED (Eq. 10)

In yet another embodiment, the ton-miles-per-hour may be determined for each tire by factoring in load distributions for left and right tires, in addition to the load distributions for front and rear sets of tires. Exemplary equations for ton-miles-per-hour are:

$$\begin{matrix}{TMPH}_{LF} = GROUND SPEED \cdot ( EVW + {PAYLOAD}_{FRONT} ) \cdot [ \frac{Δ {LF}_{FILTERED} + {LF}_{EMPTY}}{( Δ {LF}_{FILTERED} + {LF}_{EMPTY} ) + ( Δ {RF}_{FILTERED} + {RF}_{EMPTY}} ] & ( Eq . 11 ) \\ {TMPH}_{RF} = GROUND SPEED \cdot ( EVW + {PAYLOAD}_{FRONT} ) \cdot [ \frac{Δ {RF}_{FILTERED} + {RF}_{EMPTY}}{\begin{matrix}( Δ {RF}_{FILTERED} + {RF}_{EMPTY} ) + \\ ( Δ {LF}_{FILTERED} + {LF}_{EMPTY}\end{matrix}} ] & ( Eq . 12 ) \\ {TMPH}_{LR} = GROUND SPEED \cdot ( EVW + {PAYLOAD}_{REAR} ) \cdot [ \frac{Δ {LR}_{FILTERED} + {LR}_{EMPTY}}{( Δ {LR}_{FILTERED} + {LR}_{EMPTY} ) + ( Δ {RR}_{FILTERED} + {RR}_{EMPTY}} ] & ( Eq . 13 ) \\ {TMPH}_{RR} = GROUND SPEED \cdot ( EVW + {PAYLOAD}_{REAR} ) \cdot [ \frac{Δ {RR}_{FILTERED} + {RR}_{EMPTY}}{( Δ {RR}_{FILTEREDR} + {RR}_{EMPTY} ) + ( Δ {LR }_{FILTERED} + {LR}_{EMPTY}} ] & ( Eq . 14 )\end{matrix}$$

If there are more than two tires on the front or rear, e.g., the rear tires 210, 212 may have two tires per side, the appropriate equation may be divided by the number of tires on each side.

According to another embodiment, the calibration constant K in Equation 5 may be determined for each of the sets of tires on machine 102, i.e., left front, right front, left rear, and right rear. This method would result in four calibration equations with four calibration constants as shown by:

0=(k_{f}·LF_{EMPTY})+K_{LF} (Eq. 15)

0=(k_{f}·RF_{EMPTY})+K_{RF} (Eq. 16)

0=(kᵣ·LR_{EMPTY})+K_{LR} (Eq. 17)

0=(kᵣ·RR_{EMPTY})+K_{RR} (Eq. 18)

Payload may then be determined by:

PAYLOAD=k_{f}(ΔLF+ΔRF)+kᵣ(ΔLR+ΔRR)+(K_{LF}+K_{RF}+K_{LR}+K_{RR}) (Eq. 19)

The ton-miles-per-hour values for each tire may then be determined by:

$$\begin{matrix}{TMPH}_{LF} = \frac{[ ( {k}_{f} \cdot Δ LF + {K}_{LF} ) \cdot GROUND SPEED}{NUMBER OF LEFT FRONT TIRES} & ( Eq . 20 ) \\ {TMPH}_{RF} = \frac{[ ( {k}_{f} \cdot Δ RF + {K}_{RF} ) \cdot GROUND SPEED}{NUMBER OF RIGHT FRONT TIRES} & ( Eq . 21 ) \\ {TMPH}_{LR} = \frac{[ ( {k}_{r} \cdot Δ LR + {K}_{LR} ) \cdot GROUND SPEED}{NUMBER OF LEFT REAR TIRES} & ( Eq . 22 ) \\ {TMPH}_{RR} = \frac{[ ( {k}_{r} \cdot Δ RR + {K}_{RR} ) \cdot GROUND SPEED}{NUMBER OF RIGHT REAR TIRES} & ( Eq . 23 )\end{matrix}$$

It is to be understood that the embodiments described above are exemplary methods for compensating the payload on a machine 102 for uneven load distribution. It is contemplated that any appropriate method for compensating the payload on a machine may be used, without departing from the scope of the present disclosure. For example, the ton-miles-per-hour may, additionally, be based on a steering angle associated with the one or more of the tires of the machine to compensate for heat generated by stress caused by friction generated by steering the machine.

Referring again to FIG. 4, in a fifth control block 410, the ton-miles-per-hour calculations may be stored in a database 310. The calculations may be performed on a predetermined periodic basis. For example, it may be desirable to perform the ton-miles-per-hour calculations ten times per second (10 Hz.), average the calculations once per hour, and store the averages in the database 310 as machine 102 travels. However, the calculations may be performed more frequently or less frequently, as desired.

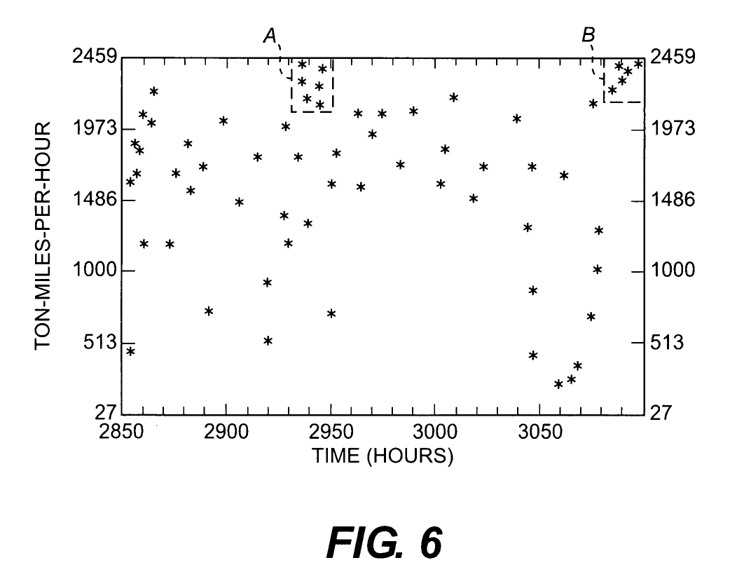

The calculations stored in the database 310 may be used to determine trends or patterns of tire wear based on excessive values of ton-miles-per-hour. Tire wear may be attributed to driver performance or road conditions. An example of an evaluation of ton-miles-per-hour is illustrated in the scatter plot shown in FIG. 6 and is described in more detail below. Additionally, the data can be incorporated into a histogram and analyzed over time to determine trends in tire wear, as shown in a sixth control block 412. Trending of data is well known in the art and will not be discussed further.

In a first decision block 414, the calculated values of ton-miles-per-hour may be monitored to determine if a predetermined threshold is exceeded. For example, an operator may determine that it is desired not to exceed a certain value of ton-miles-per-hour to avoid excessive wear on tires. If the value of ton-miles-per-hour exceeds the predetermined threshold, the operator may be notified in a seventh control block 416 by the TMPH indicator 312.

Control block 418 may include a predetermined delay to allow the operator to make appropriate operation adjustments to reduce the value of the ton-miles-per-hour, thereby avoiding damage to the tires and, potentially, to the machine. For example, once the operator of machine 102 has been notified that the ton-miles-per-hour exceeds a threshold level, control system 306 may initiate a timing signal that provides the driver with a predetermined time limit to respond to the notification and/or reduce the ground speed of the machine, which may reduce the ton-miles-per-hour.

During the predetermined delay, control system 306 may monitor the ton-miles-per-hour to determine if the operator has taken appropriate measure to ensure that the machine tires do not overheat. For example, in decision block 420 the updated values of ton-miles-per-hour may be compared with the predetermined threshold. If the value of ton-miles-per-hour exceeds the threshold (indicating that the operator has not sufficiently slowed the machine), a speed control signal may be provided (in control block 422) to the transmission and/or engine controller units to automatically limit the ground speed of the machine. Control system may continuously monitor the ton-miles-per-hour and provide the speed control signal as long as the ton-miles-per-hour exceeds the predetermined threshold, as indicated by the loop between control block 424 and 422. Once the ton-miles-per-hour value settles to below the predetermined threshold, the monitoring process may be resumed to provide a continuous, real-time tire temperature control system for a machine.

### INDUSTRIAL APPLICABILITY

Although methods and systems consistent with the disclosed embodiments are described in connection with machines, they may be applicable to any environment where it may be advantageous to monitor and/or prevent excessive tire wear. Specifically, the presently disclosed method and system for preventing tire damage on a machine may monitor an operational aspect indicative of tire wear and provide the associated control signals to limit the operational aspect, thereby limiting the amount of excessive wear on the tire. As a result, in addition to monitoring tire wear, the presently disclosed systems and methods may automatically control the machine, based on the monitored data, to limit the amount of excessive tire wear and, potentially, prevent or reduce damage to the machine.

The presently disclosed methods and systems for preventing tire damage on a machine may have several advantages. For example, because the system may automatically provide control signals that limit the speed of the machine if an excessive ton-miles-per-hour value is observed, prolonged periods of excessive wear conditions may be avoided. As a result, damage to expensive machine parts, such as axels, transmissions, and other drive train components that may result from tire failure (particularly under loaded conditions) may be significantly reduced.

In addition, the disclosed systems and methods may result in significant cost savings. For instance, the presently disclosed system may be configured to monitor the tire wear (in real-time) and take preventative measures to limit excessive wear. As a result, costs associated with the replacement and repair of tires that fail prematurely due to excessive wear, as well as productivity costs associated therewith, may be reduced and/or eliminated.

It will be apparent to those skilled in the art that various modifications and variations can be made to the disclosed methods and systems for preventing excessive tire wear on a machine. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalent.

What is claimed is:

1. A method for automatically controlling the ton-miles-per-hour of a plurality of tires on a machine, comprising:
determining the weight of a load supported by the tires;
determining the ground speed of the machine;
compensating the determined weight for uneven distribution of the load on the tires;
determining the ton-miles-per-hour for each tire based on the compensated load distribution and the ground speed;
notifying an operator if the calculated ton-miles-per-hour exceeds a predetermined threshold; and
adjusting at least one operational aspect associated with the machine if the calculated ton-miles per hour exceeds the predetermined threshold.

2. The method of claim 1, wherein the at least one operational aspect includes a transmission speed and adjusting at least one operational aspect includes providing a control signal to a transmission module associated with the machine in order to limit the transmission speed of the machine.

3. The method of claim 1, wherein that at least one operation aspect includes one of a transmission speed or an engine speed and adjusting the at least one operational aspect associated with the machine includes automatically adjusting either of the transmission speed or engine speed if the operator fails to respond to the notification.

4. The method of claim 1, wherein compensating for uneven distribution includes the step of multiplying the ton-miles-per-hour of a set of tires on the front of the machine and the ton-miles-per-hour of a set of tires on the rear of the machine by respective front and rear load distribution ratios.

5. The method of claim 4, wherein the front and rear load distribution ratios are predetermined for a machine with no load.

6. The method of claim 4, wherein the front and rear load distribution ratios are predetermined for a machine with full load.

7. The method of claim 4, wherein the front and rear load distribution ratios are predetermined for a machine with each of no load and full load.

8. The method of claim 1, wherein determining the weight of the load supported by the tires includes the steps of:
calibrating the determined weight of the machine with not load;
generating a set of pressure signals as a function of the pressure created by a load on the machine;
filtering the pressure signals; and
determining the weight of the load as the difference between the filtered pressure signals and the calibrated no load weight.

9. The method of claim 1, wherein determining the ton-miles-per-hour for each tire is further based on a steering angle associated with one or more of the tires.

10. The method of claim 1, wherein the weight of the load is determined for each of set of tires on the front of the machine and a set of tires on the rear of the machine and the weight of the load on the set of tires on the front of the machine and the weight of the load on the set of tires on the rear of the machine are determined using respective front and rear load distribution ratios.

11. The method of claim 10, wherein the ton-miles-per-hour for the tires on the left front of the machine are determined by:
$${TMPH}_{LF} = GROUND SPEED \cdot ( {LOAD}_{FRONT} ) \cdot [ \frac{Δ {LF}_{FILTERED} + {LF}_{EMPTY}}{( Δ {LF}_{FILTERED} + {LF}_{EMPTY} ) + ( Δ {RF}_{FILTERED} + {RF}_{EMPTY}} ]$$
and wherein the ton-miles-per-hour for the tires on the right front of the machine are determined by:
$${TMPH}_{RF} = GROUND SPEED \cdot ( {LOAD}_{FRONT} ) \cdot [ \frac{Δ {RF}_{FILTERED} + {RF}_{EMPTY}}{( Δ {RF}_{FILTERED} + {RF}_{EMPTY} ) + ( Δ {LF}_{FILTERED} + {LF}_{EMPTY}} ]$$
where ΔLF_{FILTERED} and ΔRF_{FILTERED} are the differences between the filtered pressure signals and the full load weights for the left front tires and the right front tires, respectively.

12. The method of claim 10, wherein the ton-miles-per-hour for the tires on the left rear of the machine are determined by:
$${TMPH}_{LR} = GROUND SPEED \cdot ( {LOAD}_{REAR} ) \cdot [ \frac{Δ {LR}_{FILTERED} + {LR}_{EMPTY}}{( Δ {LR}_{FILTERED} + {LR}_{EMPTY} ) + ( Δ {RR}_{FILTERED} + {RR}_{EMPTY}} ]$$
and wherein the ton-miles-per-hour for the tires on the right rear of the machine are determined by:
$${TMPH}_{RR} = GROUND SPEED \cdot ( {LOAD}_{REAR} ) \cdot [ \frac{Δ {RR}_{FILTERED} + {RR}_{EMPTY}}{( Δ {RR}_{FILTERED} + {RR}_{EMPTY} ) + ( Δ {LR}_{FILTERED} + {LR}_{EMPTY}} ]$$
where ΔLR_{FILTERED} and ΔRR_{FILTERED} are the differences between the filtered pressure signals and the full load weights for the left rear tires and the right rear tires, respectively.

13. A method for controlling ton-miles-per-hour of a plurality of tires on a machine, comprising:
determining the weight of a load supported by the tires;
determining the ground speed of the machine;
compensating the determined weight for uneven distribution of the load on the tires;
determining the ton-miles-per-hour for each tire based on the compensated load distribution and the ground speed; and
providing a speed control signal to one of a transmission controller or an engine controller associated with the machine if the ton-miles-per-hour exceeds a predetermined threshold, wherein the speed control signal is adapted to limit the ground speed of the machine.

14. The method of claim 13, wherein providing a speed control signal includes notifying an operator of the machine that the speed control signal is limiting the ground speed of the machine.

15. The method of claim 13, further including monitoring the ton-miles-per-hour for each tire and discontinuing the speed control signal if the ton-miles-per-hour is less than the predetermined threshold.

16. The method of claim 13, wherein compensating for uneven distribution includes the step of multiplying the ton-miles-per-hour of a set of tires on the front of the machine and the ton-miles-per-hour of a set of tires on the rear of the machine by respective front and rear load distribution ratios.

17. The method of claim 13, wherein determining the weight of the load supported by the tires includes the steps of:
calibrating the determined weight of the machine with no load;
generating a set of pressure signals as a function of the pressure created by a load on the machine;
filtering the pressure signals; and
determining the weight of the load as the difference between the filtered pressure signals and the calibrated no load weight.

18. A system for controlling the ton-miles-per-hour of a plurality of tires on a machine, comprising:
a payload monitor located on the machine that generates a payload signal;
a ground speed monitor located on the machine that generates a ground speed signal; and
a control system located on the machine, configured to:
receive the payload signal and the ground speed signal;
compensate for uneven distribution of the load on the tires;
determining the ton-miles-per-hour for each tire based on the compensated load distribution and the ground speed; and
providing a speed control signal to one of a transmission controller or an engine controller associated with the machine if the ton-miles-per-hour exceeds a predetermined threshold, wherein the speed control signal is adapted to limit the ground speed of the machine

19. The system of claim 18, wherein providing a speed control signal includes notifying an operator of the machine that the speed control signal is limiting the ground speed of the machine.

20. The system of claim 18, including a ton-miles-per-hour indicator located on the machine and adapted to receive a ton-miles-per-hour signal from the control system and responsively display a value of ton-miles-per-hour.
